(19) United States
(12) Patent Application Publication
(10) Pub. No.: US 2024/0068111 A1
(43) Pub. Date: Feb. 29, 2024

(54) POROUS TRANSPORT LAYER WITH EXCELLENT ELECTRICAL CONDUCTIVITY AND METHOD FOR PREPARING THEREOF

(71) Applicants: HYUNDAI MOTOR COMPANY, Seoul (KR); Kia Corporation, Seoul (KR)

(72) Inventors: Young June PARK, Yangpyeong-gun (KR); Seong Un LIM, Yongin-si (KR)

(73) Assignees: HYUNDAI MOTOR COMPANY, Seoul (KR); Kia Corporation, Seoul (KR)

(21) Appl. No.: 18/078,458

(22) Filed: Dec. 9, 2022

(30) Foreign Application Priority Data
Aug. 31, 2022 (KR) 10-2022-0110121

(51) Int. Cl. C25B 1/04; C25B 9/21; C25B 9/23; C25B 11/031; C25B 11/053; C25B 11/067; C25B 11/097; C25B 13/02; C25B 13/04

(52) U.S. Cl. CPC C25B 1/04; C25B 9/21; C25B 9/23; C25B 11/031; C25B 11/053; C25B 11/067; C25B 11/097; C25B 13/02; C25B 13/04

(57) ABSTRACT

The present disclosure relates to a method for preparing a porous transport layer and the porous transport layer prepared therefrom. The method includes forming a base layer by an application process using a slurry for the base layer containing particles of a titanium family element, forming a first coating layer and a second coating layer independently by application processes using a slurry for the first coating layer containing particles of a first noble metal and a slurry for the second coating layer containing particles of a second noble metal, respectively, and disposing the first coating layer and the second coating layer on both surfaces of the base layer, respectively, and the slurry for the first coating layer further contains the particles of the titanium family element.

### CROSS-REFERENCE TO RELATED APPLICATION

This application claims the benefit of priority to Korean Patent Application No. 10⁻²⁰²²-0110121, filed in the Korean Intellectual Property Office on Aug. 31, 2022, the entire contents of which are incorporated herein by reference.

### TECHNICAL FIELD

The present disclosure relates to a porous transport layer with an excellent electrical conductivity, and a method for effectively preparing the porous transport layer without additional processes or equipment.

### BACKGROUND

A polymer electrolyte membrane (PEM) water electrolysis system is an electro-chemical conversion device that uses electricity to decompose water (H₂O) into hydrogen (H₂) and oxygen (O₂). The PEM water electrolysis system may be operated at a high current density and make a fast response, which may compensate for a power fluctuation of intermittent renewable energy such as wind power and solar power, may have a low gas permeability via a solid electrolyte membrane, which may allow high-purity hydrogen and oxygen to be produced, and may have a high stability. Such PEM water electrolysis system is composed of a PEM water electrolysis stack and a peripheral device for driving the same, and the PEM water electrolysis stack is composed of multiple PEM water electrolysis cells.

In this regard, referring to FIG. 1, the PEM water electrolysis cell typically includes a membrane-electrode assembly (MEA) including an electrolyte membrane 10, an anode electrode 20, and a cathode electrode 30, a gas diffusion layer (GDL) 40 for the cathode, a porous transport layer (PTL) 50 for the anode, a separator 60 for the cathode, and a separator 70 for the anode. In this regard, water introduced via a separator flow path “a” for the anode is supplied to the anode 20 via the PTL 50, and hydrogen gas generated at the cathode 30 is discharged via the GDL 40 and a separator flow path “b” for the cathode. In an electrochemical reaction of such PEM water electrolysis cell, after water supplied to the anode is separated into hydrogen ions (H⁺) and electrons together with oxygen gas by an oxygen evolution reaction (OER), the hydrogen ions (H⁺) and the electrons move to the cathode via the electrolyte membrane and an external circuit, respectively, and generate hydrogen gas by a hydrogen evolution reaction.

The PTL serves to uniformly distribute and/or diffuse water as a reactant on a surface of the anode electrode, discharge oxygen generated at the anode electrode to the outside via the separator, and collect and/or transport the electrons generated by the electrochemical reaction. To maximize such functions of the PTL, various physical properties such as a corrosion resistance, an electrical conductivity, a distributivity and a diffusivity, a low surface roughness, and a mechanical strength are essential.

In this regard, a material having the excellent electrical conductivity, thermal conductivity, and corrosion resistance and having low ohmic loss and mass transport loss is preferred as the PTL. Accordingly, it is common that a conventional PTL is made of titanium (Ti) having excellent physical and chemical properties because corrosion does not occur even under high potential and acidic conditions. However, titanium has a problem in that it is easily contaminated and oxidized by an atmospheric environment because of a nature of the material. Accordingly, in the titanium-based PTL, after molding and sintering processes, TiO, is generated on a surface of the PTL to increase an electrical resistance, thereby reducing a performance and a durability of the hydrogen electrolysis (water electrolysis) stack.

As an alternative to such problem, a method for coating a noble metal material such as platinum, iridium, gold, and silver as a protective layer of the titanium-based PTL in an electrolytic plating scheme after the molding and sintering processes has been proposed. For example, Japanese Patent Application Publication 1998-102273 (Patent Document 1) discloses a water electrolysis cell having a power supply body in which the platinum plating is applied to a surface of a metal sintered body. Specifically, in the method for plating the noble metal such as platinum on the surface of the metal sintered body (PTL) as in Patent Document 1, it is common that a separate process of plating the noble metal is performed after the PTL molding and sintering processes. However, such separate plating process requires equipment for the plating, and the PTL is fixed to a cradle for the coating, which cause a problem that the noble metal coating layer is not plated on a fixed portion of the PTL. In addition, because the separate plating process is performed after the sintering process, there is a limit that the plating process should be performed as a sheet-to-sheet process in consideration of a rigidity of the PTL.

Therefore, it is necessary to research and develop a method for preparing a porous transport layer that enables process simplification and has excellent electrical conductivity as a noble metal coating layer may be formed on a surface thereof without additional processes or equipment, and the porous transport layer prepared therefrom.

### SUMMARY

The present disclosure has been made to solve the above-mentioned problems occurring in the related art while advantages achieved by the related art are maintained intact.

An aspect of the present disclosure provides a method for preparing a porous transport layer that enables process simplification, has an excellent PTL protection effect compared to an amount of use of a noble metal, and has an excellent electrical conductivity as a noble metal coating layer may be formed on a surface thereof without additional processes or equipment, and the porous transport layer prepared therefrom.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method for preparing a porous transport layer includes forming a base layer by a first application process using a slurry for the base layer containing particles of a titanium family element,
forming a first coating layer and a second coating layer independently by second and third application processes using a slurry for the first coating layer containing particles of a first noble metal and the particles of the titanium family element, and a slurry for the second coating layer containing particles of a second noble metal, respectively, and
disposing the first coating layer and the second coating layer on both surfaces of the base layer, respectively.

According to another aspect of the present disclosure, a porous transport layer includes a base layer containing particles of a titanium family element,
a first coating layer disposed on one surface of the base layer, the first coating layer containing particles of a first noble metal and the particles of the titanium family element, and
a second coating layer containing particles of a second noble metal and disposed on the other surface of the base layer.

According to another aspect of the present disclosure, a water electrolysis cell or a fuel cell includes the porous transport layer.

### BRIEF DESCRIPTION OF THE DRAWINGS

The above and other objects, features and advantages of the present disclosure will be more apparent from the following detailed description taken in conjunction with the accompanying drawings:

FIG. 1 is a cross-sectional view of a typical polymer electrolyte membrane (PEM) water electrolysis cell;

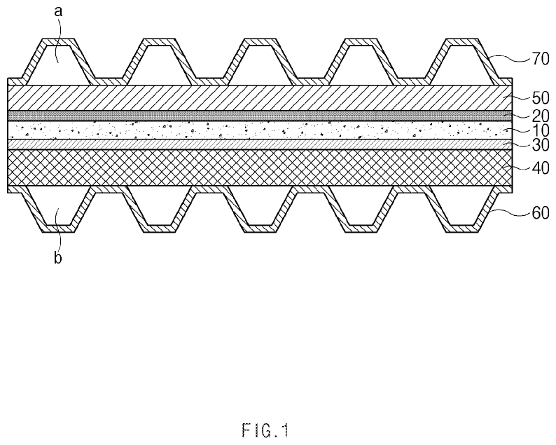

FIG. 2 is a cross-sectional view of a porous transport layer according to an embodiment of the present disclosure;

FIG. 3 is a cross-sectional view of a water electrolysis cell according to an embodiment of the present disclosure;

FIG. 4 is a schematic diagram of a method for preparing a porous transport layer in a roll-to-roll scheme according to an embodiment of the present disclosure; and

FIG. 5 is a surface roughness result measured in Test Example of the present disclosure.

### DETAILED DESCRIPTION

Herein, when a component “includes” a certain component, it means that other components may be further included, rather than excluding said other components unless otherwise stated.

Herein, when a member is located on a “surface”, “one surface”, “the other surface” or “both surfaces” of another member, this includes not only a case in which the member is in contact with said another member, but also a case in which still another member exists between the two members.

Method for Preparing Porous Transport Layer

A method for preparing a porous transport layer according to the present disclosure includes: forming a base layer; forming a first coating layer and a second coating layer; and disposing the first coating layer and the second coating layer on both surfaces of the base layer, respectively.

Forming Base Layer

In this operation, the base layer is formed by an application process (a first application process) using a slurry for the base layer containing particles of a titanium family element (e.g., a Group 4 element).

The titanium family element may include at least one selected from a group consisting of titanium, zirconium, and hafnium. Specifically, the titanium family element may include titanium.

The particles of the titanium family element may be used without any particular limitation as long as they have a form that may be used in preparing the PTL in general, and, for example, may be circular, oval, amorphous, or fibrous.

In addition, the particles of the titanium family element may have an average size in a range from 20 to 80 μm, from 25 to 45 μm, or from 30 to 50 μm. When the average size of the particles of the titanium family element is smaller than the above range, a porosity and a rigidity of the prepared base layer may be too low. When the average size exceeds the above range, because the porosity of the prepared base layer is too high and a roughness thereof is high, a resistance may be high, which may lower a performance of the porous transport layer. In this regard, an average diameter of the particles may be a particle diameter of cumulative distribution 50% (D₅₀) in a particle diameter distribution measured using a particle size analyzer (PSA).

The slurry for the base layer may contain the particles of the titanium family element, a solvent, a dispersant, and a binder.

The solvent may be used without any particular limitation as long as it is a solvent that may be used in preparing the PTL in general, and, for example, may include ethanol, toluene, and the like.

The dispersant may be used without any particular limitation as long as it may be used in preparing the PTL production in general, and for example, may include at least one selected from a group consisting of water, ethanol, methanol, isopropanol, xylene, cyclohexanone, acetone, toluene, and methyl ethyl ketone.

The binder may be used without any particular limitation as long as it may be used in preparing the PTL production in general, and for example, may include at least one selected from a group consisting of polyvinyl butyral (PVB), polyvinyl alcohol (PVA), polyvinyl chloride (PVC), polyvinyl acetate (PVAc), and polyacrylonitrile.

In this regard, the slurry for the base layer may contain the particles of the titanium family element in an amount of 75 to 98% by weight, and contain the solvent, the dispersant, and the binder such that a total amount thereof is 2 to 25% by weight. Specifically, the slurry for the base layer may contain the particles of the titanium family element in an amount of 85 to 98% by weight, and may contain the solvent, the dispersant, and the binder such that the total amount thereof is 2 to 15% by weight. When a content of the particles of the titanium family element in the slurry for the base layer is smaller than the above range, there may be a problem that sintering is not available or the porosity of the prepared base layer is too high because of a long distance between particles of the titanium family element during a heat treatment process. When the content of the particles of the titanium family element exceeds the above range, there may be a problem that, because an amount of evaporation of the binder during the heat treatment process is excessively great, a process difficulty increases or the porosity becomes too low. In addition, when the total amount of the solvent, the dispersant, and the binder in the slurry for the base layer is smaller than the above range, there may be the problem that, because the amount of evaporation of the binder during the heat treatment process is excessively great, the process difficulty increases or the porosity of the prepared base layer becomes too low. When the total amount of the solvent, the dispersant, and the binder exceeds the above range, there may be the problem that the sintering is not available or the porosity of the prepared base layer is too high because of the long distance between particles of the titanium family element during the heat treatment process.

Specifically, the slurry for the base layer may contain the particles of the titanium family element in an amount of 75 to 98% by weight, the solvent in an amount of 1.5 to 20% by weight, the dispersant in an amount of 0.1 to 5% by weight, and the binder in an amount of 0.1 to 5% by weight. More specifically, the slurry for the base layer may contain the particles of the titanium family element in an amount of 85 to 98% by weight, the solvent in an amount of 1.5 to 12% by weight, the dispersant in an amount of 0.5 to 2% by weight, and the binder in an amount of 0.5 to 2% by weight.

When a content of the solvent in the slurry for the base layer is smaller than the above range, a coating property of the slurry may be lowered, and thus, the base layer may be formed to have a non-uniform thickness or a porosity deviation may occur. When the content of the solvent exceeds the above range, contamination of a material and equipment may occur caused by excessive evaporation of the solvent during the sintering.

In addition, when a content of the dispersant in the slurry for the base layer is smaller than the above range, agglomerates of the particles of the titanium family element may undesirably form during preparation of the slurry. When the content of the dispersant exceeds the above range, a problem that a viscosity is low to perform a coating process may occur.

Furthermore, when a content of the binder in the slurry for the base layer is smaller than the above range, there may be a problem that it is difficult to maintain a sheet shape because of insufficient binding force between the particles of the titanium family element in the prepared base layer. When the content of the binder exceeds the above range, a binding force of the components in the slurry is strong, which may cause a problem that the components are adhered to a lower substrate during the coating process.

In addition, the slurry for the base layer may be prepared by stirring, specifically, mixing the particles of the titanium family element, the solvent, the dispersant, and the binder with each other by a ball mill process. In this regard, a stirring time may be 15 to 30 hours or 18 to 24 hours, but may not be limited thereto, and may be a time during which the particles of the titanium family element, the solvent, the dispersant, and the binder may be uniformly mixed with each other.

The slurry for the base layer may have the viscosity in a range from 40 to 800 cP, from 40 to 700 cP, or from 50 to 500 cP at 25° C. When the viscosity at 25° C. of the slurry for the base layer is within the above range, there are effects such as the application workability of the slurry is excellent and the prepared base layer may be formed to have a uniform thickness. In addition, when the viscosity at 25° C. of the slurry for the base layer is smaller than the above range, there may be a problem that, because the thickness of the prepared base layer is non-uniform, a surface roughness of the base layer increases. When the viscosity at 25° C. of the slurry for the base layer exceeds the above range, there may be a problem of insufficient application workability of the slurry.

The application process may be selected from a group consisting of comma coating, slot die coating, gravure coating, lip coating, cap coating, bar coating, doctor blade coating, and tape casting.

The base layer may have an average thickness in a range from 20 to 1,000 μm, from 200 to 800 μm, or from 200 to 300 μm. When the average thickness of the base layer is smaller than the above range, there may be a problem that, as the rigidity of the base layer is too low to form a uniform surface pressure in a stack, the performance of the porous transport layer is reduced. When the average thickness of the base layer exceeds the above range, because a mass transfer resistance may be too high, the performance of the porous transport layer may be insufficient in a high current section.

The base layer prepared by the application process may be dried. In this regard, the drying may be performed in a temperature range from 60 to 90° C. or from 70 to 80° C. Via the drying, a portion of the solvent in the base layer may be evaporated to improve adhesion with the first coating layer and/or the second coating layer. When the temperature during the drying is lower than the above range, because the solvent may not evaporate, the material may be contaminated. When the temperature during the drying exceeds the above range, there may be a problem that an economic feasibility is lowered because of the slight improvements achieved when the temperature during the drying increases.

Forming First Coating Layer and Second Coating Layer

In this operation, the first coating layer and the second coating layer are independently formed by the application processes (second and third application processes) using a slurry for the first coating layer containing particles of a first noble metal and a slurry for the second coating layer containing particles of a second noble metal, respectively.

Each of the first noble metal and the second noble metal may contain at least one selected from a group consisting of platinum (Pt), gold (Au), iridium (Ir), ruthenium (Ru), palladium (Pd), rhodium (Rh), silver (Ag), and osmium (Os). Each of the first noble metal and the second noble metal may be a coinage metal, and may use gold (Au) or silver (Ag), or use platinum, iridium, ruthenium, palladium, rhodium, osmium, and the like as platinum group elements.

The particles of each of the first noble metal and the second noble metal may be used without any particular limitation as long as they are in a form that may be used in preparing the PTL in general, and for example, may be circular, oval, amorphous, or fibrous.

In addition, the particles of each of the first noble metal and the second noble metal may have an average size in a range from 5 to 100 μm, from 5 to 20 μm, or from 5 to 10 μm. When the average size of the particles of each of the first noble metal and the second noble metal is smaller than the above range, there may be a problem that the coating has to be performed for a long time in the coating process. When the average size of the particles of each of the first noble metal and the second noble metal exceeds the above range, there may be a problem that the noble metal is not coated over an entire area and some of the particles of the titanium family element in the base layer are exposed at a surface of the base layer. In this regard, an average diameter of the particles may be the particle diameter of the cumulative distribution 50% (D₅₀) in the particle diameter distribution measured using the particle size analyzer (PSA).

The slurry for the first coating layer further contains the particles of the titanium family element. When the slurry for the first coating layer contains the particles of the titanium family element, a porous transport layer may improve a performance of a water electrolysis cell or a fuel cell because a cost is reduced as an amount of use of the expensive noble metal is reduced, and a base layer protection effect is excellent.

In addition, each of the slurry for the first coating layer and the slurry for the second coating layer may additionally contain the solvent, the dispersant, and the binder. In this regard, the solvent, the dispersant, and the binder are the same as described in the slurry for the base layer. In addition, the slurry for the base layer, the slurry for the first coating layer, and the slurry for the second coating layer may contain the same solvent, dispersant, and binder. As described above, when the slurries contain the same solvent, dispersant, and binder, cracks and breakage caused by a difference in a shrinkage rate between layers may be prevented during degreasing and sintering processes.

The slurry for the first coating layer may contain the particles of the first noble metal in an amount of 75 to 95% by weight and the particles of the titanium family element in an amount of 1 to 15% by weight, and may contain the solvent, the dispersant, and the binder such that the total amount thereof is 2 to 15% by weight. Specifically, the slurry for the first coating layer may contain the particles of the first noble metal in an amount of 80 to 90% by weight and the particles of the titanium family element in an amount of 1 to 15% by weight, and may contain the solvent, the dispersant, and the binder such that the total amount thereof is 3 to 10% by weight.

When a content of the particles of the first noble metal in the slurry for the first coating layer is smaller than the above range, because an electrical conductivity and a contact resistance are reduced, the performance of the porous transport layer may be lowered. When the content of the particles of the first noble metal in the slurry for the first coating layer exceeds the above range, the economic feasibility may decrease as the cost increases.

In addition, when a content of the particles of the titanium family element in the slurry for the first coating layer is smaller than the above range, there may be a problem that sintering is not available or a porosity of the coating layer is too high because of a long distance between particles of the titanium family element during a heat treatment process. When the content of the particles of the titanium family element exceeds the above range, there may be a problem that, because an amount of evaporation of the binder during the heat treatment process is excessively great, a process difficulty increases or the porosity becomes too low.

When the total amount of the solvent, the dispersant, and the binder in the slurry for the first coating layer is smaller than the above range, there may be a problem that the components in the slurry are not uniformly mixed with each other. When the total amount of the solvent, the dispersant, and the binder in the slurry for the first coating layer exceeds the above range, there may be a problem that, because the amount of evaporation of the binder during the heat treatment process is excessively great, the process difficulty increases or the porosity of the first coating layer becomes too low.

Specifically, the slurry for the first coating layer may contain the particles of the first noble metal in an amount of 75 to 95% by weight, the particles of the titanium family element in an amount of 2 to 15% by weight, the solvent in an amount of 1 to 10% by weight, the dispersant in an amount of 0.1 to 3% by weight, and the binder in an amount of 0.1 to 3% by weight. More specifically, the slurry for the first coating layer may contain the particles of the first noble metal in an amount of 80 to 90% by weight, the particles of the titanium family element of in an amount 5 to 15% by weight, the solvent in an amount of 2 to 4% by weight, the dispersant in an amount of 0.5 to 3% by weight, and the binder in an amount of 0.5 to 3% by weight.

When a content of the solvent in the slurry for the first coating layer is smaller than the above range, a coating property of the slurry may be lowered, and thus, the first coating layer may be formed to have a non-uniform thickness or a porosity deviation may occur. When the content of the solvent exceeds the above range, contamination of a material and equipment may occur caused by excessive evaporation of the solvent during the sintering.

In addition, when a content of the dispersant in the slurry for the first coating layer is smaller than the above range, agglomerates of the particles of the titanium family element and/or the particles of the first noble metal may undesirably form during preparation of the slurry. When the content of the dispersant exceeds the above range, an electrical resistance may be increased or the porosity may be excessively increased because of a long distance between the noble metal particles during the heat treatment process.

Furthermore, when a content of the binder in the slurry for the first coating layer is smaller than the above range, there may be a problem that it is difficult to maintain a sheet shape because of insufficient binding force between the particles of the titanium family element and/or the particles of the first noble metal in the prepared first coating layer. When the content of the binder exceeds the above range, a binding force of the slurry is strong, which may cause a problem that the slurry is adhered to a lower substrate during the coating process.

The slurry for the second coating layer may contain the particles of the second noble metal in an amount of 80 to 99% by weight, and may contain the solvent, the dispersant, and the binder such that the total amount thereof is 1 to 15% by weight. Specifically, the slurry for the second coating layer may contain the particles of the second noble metal in an amount of 85 to 98% by weight or 91 to 97% by weight, and may contain the solvent, the dispersant, and the binder such that the total amount thereof is 2 to 15% by weight or 3 to 9% by weight.

When a content of the particles of the second noble metal in the slurry for the second coating layer is smaller than the above range, a contact resistance may be increased and the titanium family element in the base layer may be exposed to atmosphere. When the content of the particles of the second noble metal in the slurry for the second coating layer exceeds the above range, the economic feasibility may decrease as the cost excessively increases.

In addition, when the total amount of the solvent, the dispersant, and the binder in the slurry for the second coating layer is smaller than the above range, there may be a problem that the components in the slurry are not uniformly mixed with each other. When the total amount of the solvent, the dispersant, and the binder in the slurry for the second coating layer exceeds the above range, there may be a problem that, because the amount of evaporation of the binder during the heat treatment process is excessively great, the process difficulty increases or the porosity of the first coating layer becomes too low.

Specifically, the slurry for the second coating layer may contain the particles of the second noble metal in an amount of 85 to 98% by weight, the solvent in an amount of 1 to 10% by weight, the dispersant in an amount of 0.1 to 3% by weight, and the binder in an amount of 0.1 to 3% by weight. More specifically, the slurry for the second coating layer may contain the particles of the second noble metal in an amount of 91 to 97% by weight, the solvent in an amount of 2 to 5% by weight, the dispersant in an amount of 0.5 to 2% by weight, and the binder in an amount of 0.5 to 2% by weight.

When a content of the solvent in the slurry for the second coating layer is smaller than the above range, a coating property of the slurry may be lowered, and thus, the second coating layer may be formed to have a non-uniform thickness or a porosity deviation may occur. When the content of the solvent exceeds the above range, contamination of the material and the equipment may occur caused by excessive evaporation of the solvent during the sintering.

In addition, when a content of the dispersant in the slurry for the second coating layer is smaller than the above range, agglomerates of the particles of the second noble metal may undesirably form during preparation of the slurry. When the content of the dispersant exceeds the above range, the economic feasibility may decrease as the cost excessively increases.

Furthermore, when a content of the binder in the slurry for the second coating layer is smaller than the above range, there may be a problem that it is difficult to maintain a sheet shape because of insufficient binding force between the particles of the second noble metal in the prepared second coating layer. When the content of the binder exceeds the above range, a binding force of the slurry is strong, which may cause a problem that the slurry is adhered to a lower substrate during the coating process.

The slurry for the second coating layer may further contain the particles of the titanium family element. When the slurry for the second coating layer contains the particles of the titanium family element, the porous transport layer may improve the performance of the water electrolysis cell or the fuel cell because the cost is reduced as the amount of use of the expensive noble metal is reduced, and the base layer protection effect is excellent.

For example, the slurry for the second coating layer may contain the particles of the second noble metal in an amount of 80 to 97% by weight and the particles of the titanium family element in an amount of 1 to 15% by weight, and may contain the solvent, the dispersant, and the binder such that the total amount thereof is 1 to 7% by weight. Specifically, the slurry for the second coating layer may contain the particles of the second noble metal in an amount of 80 to 90% by weight, and may contain the solvent, the dispersant, and the binder such that the total amount thereof is 3 to 5% by weight. More specifically, the slurry for the second coating layer may contain the particles of the second noble metal in an amount of 80 to 95% by weight or 80 to 90% by weight, the particles of the titanium family element in an amount of 1 to 15% by weight or 5 to 15% by weight, the solvent in an amount of 1 to 5% by weight or 2 to 4% by weight, the dispersant in an amount of 0.1 to 3% by weight or 0.5 to 2% by weight, and the binder in an amount of 0.1 to 3% by weight or 0.5 to 2% by weight.

More specifically, the slurry for the base layer, the slurry for the first coating layer, and the slurry for the second coating layer may have the same solvent content. When the slurries have the same solvent content, the cracks and the breakage caused by the difference in the shrinkage rate between the layers may be prevented during the degreasing and sintering processes.

In addition, each of the slurry for the first coating layer and the slurry for the second coating layer may be prepared by stirring, specifically, mixing the components with each other by the ball mill process. In this regard, a stirring time may be 15 to 30 hours or 18 to 24 hours, but may not be limited thereto, and may be a time during which the components may be uniformly mixed with each other.

The application process to form the first and second coating layers may each be selected from the group consisting of the comma coating, the slot die coating, the gravure coating, the lip coating, the cap coating, the bar coating, the doctor blade coating, and the tape casting.

The first coating layer may have an average thickness in a range from 20 to 100 μm, from 20 to 80 μm, or from 20 to 40 μm. When the average thickness of the first coating layer is smaller than the above range, the contact resistance may be increased and the particles of the titanium family element in the base layer may be exposed to the atmosphere. When the average thickness of the first coating layer exceeds the above range, because the cost excessively increases, the economic feasibility may decrease.

The second coating layer may have an average thickness in a range from 20 to 100 μm, from 20 to 80 μm, or from 20 to 40 μm. When the average thickness of the second coating layer is smaller than the above range, the contact resistance may be increased and the particles of the titanium family element in the base layer may be exposed to the atmosphere. When the average thickness of the second coating layer exceeds the above range, because the cost excessively increases, the economic feasibility may decrease.

The first coating layer and the second coating layer prepared by the application process may be independently dried. In this regard, the drying may be performed in a temperature range from 60 to 90° C. or from 70 to 80° C. By evaporating a portion of the solvent in each of the first coating layer and the second coating layer via the drying, adhesion with the base layer may be improved. When the temperature during the drying is lower than the above range, because the solvent may not evaporate, the material may be contaminated. When the temperature during the drying exceeds the above range, there may be the problem that the economic feasibility is lowered because of the slight improvements achieved when the temperature during the drying increases.

That is, the base layer, the first coating layer, and the second coating layer prepared by the application process may be independently dried and then stacked on top of each other. Via such drying, a slip phenomenon at an interface between the layers may be prevented during the stacking.

Stacking Layers on Top of Each Other

In this operation, the first coating layer and the second coating layer are respectively disposed on the both surfaces of the base layer.

For example, the disposition may be performed by a roll-to-roll scheme. For this reason, the preparation method of the present disclosure is economical and has an excellent process efficiency because a process cost is reduced compared to the conventional preparation method using the plating.

In addition, a green sheet in which the first coating layer and the second coating layer are respectively disposed on the both surfaces of the base layer may be adhered to prevent the slip phenomenon at the interface between the layers. The adhesion may be performed while applying a pressure equal to or lower than 300 kgf in a temperature range from 15 to 30° C. or from 20 to 25° C. When the temperature during the adhesion exceeds the above range, that is, when the green sheet is adhered while being heated, the solvent and/or the binder may evaporate, and thus, the cracks may occur. In addition, when the pressure during the adhesion exceeds the above range, the green sheet may be broken or the layers are mixed with each other, so that the base layer protection effect may be insufficient, which may lower the performance of the water electrolysis cell or the fuel cell including the same.

The preparation method may additionally include, after the disposing of the layers as described above:
removing the solvent and the binder by degreasing the green sheet in which the first coating layer and the second coating layer are respectively disposed on the both surfaces of the base layer; and
sintering the degreased green sheet to prepare the porous transport layer.

Degreasing

The degreasing may be performed at a temperature at which the solvent and the binder in the green sheet may be removed. For example, the degreasing may be performed in a temperature range from 500 to 800° C. or from 600 to 750° C. When the temperature during the degreasing is smaller than the above range, there may be a problem that the solvent remains and does not entirely evaporate. When the temperature during the degreasing exceeds the above range, the titanium family element in the base layer may be oxidized as a sintering temperature is reached in an atmosphere other than a vacuum atmosphere.

The degreased green sheet may be in a state in which the interfaces between the layers are not connected to each other. Accordingly, by sintering the degreased green sheet, the layers may be connected to each other.

Sintering

The sintering may be performed at a temperature and a pressure applicable in preparing the PTL, and, for example, may be performed in a temperature range from 900 to 1,500° C. or from 1,000 to 1,300° C., and in a degree of vacuum range from 10⁻⁸ to 10⁻³ Torr or from 10⁻⁷ to 10⁻⁶ Torr. When the temperature during the sintering is lower than the above range, there may be a problem that the particles of the titanium family element is not sintered. When the temperature during the sintering exceeds the above range, because particles of the titanium family element may be excessively sintered, pores may be blocked or an excessive thickness deviation may occur. In addition, when the degree of vacuum during the sintering is lower than the above range, there may be a problem that the titanium family element is oxidized at a high temperature. When the degree of vacuum during the sintering exceeds the above range, there may be a problem that the process cost increases because a vacuum pump of a high-spec more than necessary is required.

The method for preparing the porous transport layer according to the present disclosure as described above is able to simplify the process because the noble metal coating layer may be formed on the surface thereof without the additional process operations or equipment, and has the very excellent process cost and process efficiency because the roll-to-roll scheme is applicable as the noble metal coating layer is disposed before the sintering process of the PTL.

Porous Transport Layer

The porous transport layer according to the present disclosure includes: the base layer containing the particles of the titanium family element; the first coating layer containing the particles of the first noble metal formed on one surface of the base layer; and the second coating layer containing the particles of the second noble metal famed on the other surface of the base layer.

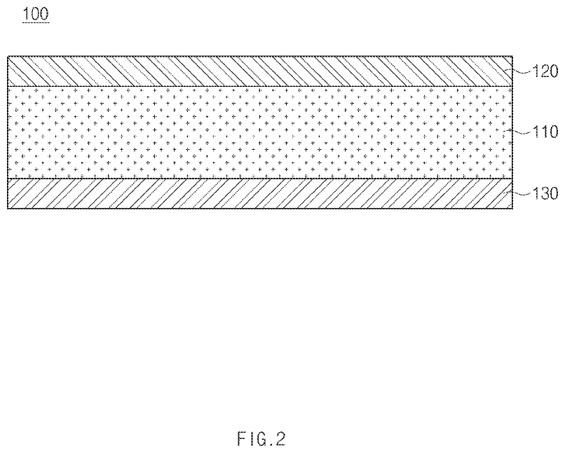

Referring to FIG. 2, a porous transport layer 100 according to the present disclosure may include a base layer 110; a first coating layer 120 formed on one surface of the base layer 110; and a second coating layer 130 formed on the other surface of the base layer 110.

Base Layer

The base layer serves to uniformly distribute and/or diffuse water as a reactant on a surface of an anode, and discharge oxygen generated at the anode to the outside via a separator.

The titanium family element may include at least one selected from a group consisting of titanium, zirconium, and hafnium. Specifically, the titanium family element may include titanium.

In addition, a shape and an average diameter of the particles of the titanium family element are the same as described in the preparation method.

The base layer may have an average thickness in a range from 20 to 1,000 μm, from 300 to 800 μm, or from 200 to 300 μm. When the average thickness of the base layer is smaller than the above range, there may be a problem that, as a rigidity of the base layer is too low to form a uniform surface pressure in a stack, a performance of the porous transport layer is reduced. When the average thickness of the base layer exceeds the above range, because a mass transfer resistance may be too high, the performance of the porous transport layer may be reduced in a high current section.

First Coating Layer

The particles of the first noble metal and/or the particles of the titanium family element in the first coating layer are hydrogenated instead of the particles of the titanium family element in the base layer so as to prevent a problem that a performance and a durability of a hydrogen electrolysis (water electrolysis) stack are reduced as an electrical resistance of the PTL increases.

The first coating layer contains the particles of the first noble metal and the particles of the titanium family element. For example, the first noble metal may include at least one selected from a group consisting of platinum (Pt), gold (Au), iridium (Ir), ruthenium (Ru), palladium (Pd), rhodium (Rh), silver (Ag), and osmium (Os).

In this regard, shapes and average diameters of the particles of the first noble metal and the titanium family element are the same as those described in the preparation method.

The first coating layer may have an average thickness in a range from 20 to 100 μm, from 20 to 80 μm, or from 20 to 40 μm. When the average thickness of the first coating layer is smaller than the above range, a contact resistance may be increased and the titanium family element in the base layer may be exposed to atmosphere. When the average thickness of the first coating layer exceeds the above range, because a cost excessively increases, an economic feasibility may decrease.

Second Coating Layer

The particles of the second noble metal in the second coating layer are hydrogenated instead of the particles of the titanium family element in the base layer so as to prevent the problem that the performance and the durability of the hydrogen electrolysis (water electrolysis) stack are reduced as the electrical resistance of the PTL increases.

The second coating layer contains the particles of the second noble metal. For example, the second noble metal may include at least one selected from a group consisting of platinum (Pt), gold (Au), iridium (Ir), ruthenium (Ru), palladium (Pd), rhodium (Rh), silver (Ag), and osmium (Os). In this regard, a shape and an average diameter of the particles of the second noble metal are the same as those described in the preparation method.

In addition, the second coating layer may additionally contain the particles of the titanium family element. In this regard, a shape and an average diameter of the particles of the titanium family element that may be contained in the second coating layer are the same as those described in the preparation method.

The second coating layer may have an average thickness in a range from 20 to 100 μm, from 20 to 80 μm, or from 20 to 40 μm. When the average thickness of the second coating layer is smaller than the above range, the contact resistance may be increased and the titanium family element in the base layer may be exposed to the atmosphere. When the average thickness of the second coating layer exceeds the above range, because the cost excessively increases, the economic feasibility may decrease.

The porous transport layer according to the present disclosure as described above may be suitably used as a material for the water electrolysis cell or the fuel cell because of an excellent PTL protection effect compared to an amount of use of the noble metal and excellent corrosion resistance and electrical conductivity.

Water Electrolysis Cell or Fuel Cell

The water electrolysis cell or the fuel cell of the present disclosure includes the porous transport layer as described above.

For example, a membrane-electrode assembly (MEA) may be stacked at a side of the second coating layer of the porous transport layer, and a separator for the anode may be stacked at a side of the first coating layer.

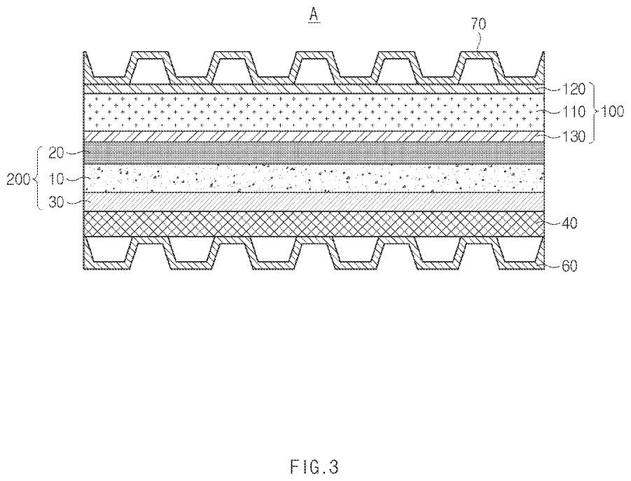

Referring to FIG. 3, a water electrolysis cell “A” according to the present disclosure may have a form in which the separator 70 for the anode; the porous transport layer (PTL) 100 including the first coating layer 120, the base layer 110, and the second coating layer 130; a membrane-electrode assembly (MEA) 200 including the anode electrode 20, the electrolyte membrane 10, and the cathode electrode 30; the gas diffusion layer (GDL) 40; and the separator 60 for the cathode are sequentially stacked on top of each other.

Hereinafter, the present disclosure will be described in more detail through Examples. However, such Examples are only for helping the understanding of the present disclosure, and the scope of the present disclosure is not limited to such Examples in any sense.

### EXAMPLES

### Preparation Example 1. Preparation of Slurry-1 for Base Layer

A slurry-1 for the base layer was prepared by mixing 95 parts by weight of titanium (Ti) having the average particle diameter (D₅₀) of 40 μm and 5 parts by weight of ethanol with each other. The prepared slurry-1 for the base layer had the viscosity of 230 cP at 25° C.

### Preparation Example 2. Preparation of Slurry-2 for Base Layer

A slurry-2 for the base layer was prepared by mixing 70 parts by weight of titanium (Ti) having the average particle diameter (D₅₀) of 40 μm and 30 parts by weight of ethanol with each other. The prepared slurry-2 for the base layer had the viscosity of 20 cP at 25° C.

### Preparation Example 3. Preparation of Slurry for First Coating Layer

A slurry for the first coating layer was prepared by mixing 80 parts by weight of platinum (Pt) having the average particle diameter (D₅₀) of 8 μm, 15 parts by weight of titanium (Ti) having the average particle diameter (D₅₀) of 40 μm, and 5 parts by weight of ethanol with each other.

### Preparation Example 4. Preparation of Slurry for Second Coating Layer

A slurry for the second coating layer was prepared by mixing 95 parts by weight of platinum (Pt) having the average particle diameter (D₅₀) of 8 μm and 5 parts by weight of ethanol with each other.

### Test Example 1. Surface Roughness of Porous Transport Layer

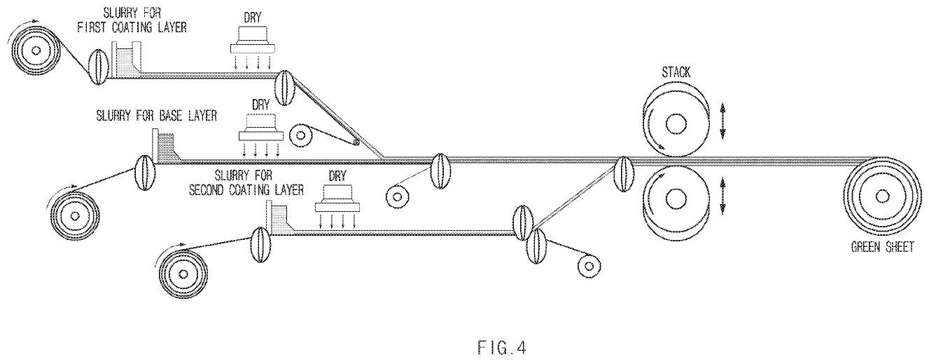

The slurries for the base layer in Preparation Examples 1 and 2, the slurry for the first coating layer in Preparation Example 3, and the slurry for the second coating layer in Preparation Example 4 were applied by comma coating, dried at 70° C., and then were stacked on top of each other in an order of the first coating layer, the base layer, and the second coating layer in the roll-to-roll scheme as shown in FIG. 4 to prepare the green sheet. Thereafter, the green sheet was degreased at 700° C., and sintered at 1,100° C. and the vacuum degree of 10⁻⁶ Torr to prepare the porous transport layer. In this regard, the slurry for the first coating layer had the thickness of 20 μm when being applied, the slurry for the base layer had the thickness of 260 μm when being applied, and the slurry for the second coating layer had the thickness of 20 μm when being applied.

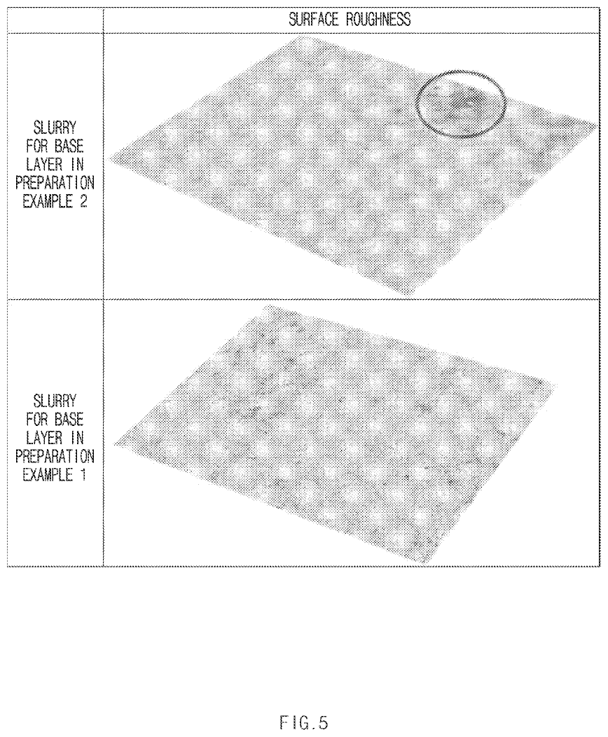

The surface roughness of the prepared porous transport layer was measured using a surface roughness measuring instrument, and a result thereof is shown in FIG. 5.

As shown in FIG. 5, the slurry for the base layer in Preparation Example 2 containing an excess of solvent had a strong binding force, which caused a problem that the slurry is adhered to the lower substrate during the coating process. Accordingly, a portion of the prepared porous transport layer was dented, and thus, a surface smoothness was very poor.

On the other hand, the porous transport layer prepared using the slurry for the base layer in Preparation Example 1 had a uniform surface roughness, and thus, had excellent surface smoothness.

### Preparation Examples 5 to 7. Preparation of Slurry for First Coating Layer

Slurries for the first coating layer were prepared in the same manner as in Preparation Example 3, except that contents of platinum in the slurries were adjusted as shown in Table 1 below.

### Test Example 2. Contact Resistance of Porous Transport Layer

The porous transport layers were prepared in the same manner as in Test Example 1, except that the slurries for the first coating layer in Preparation Examples 3 and 5 to 7 were used. Thereafter, the contact resistance was measured using a contact resistance measuring instrument for the porous transport layer, and a result thereof is shown in Table 1.

TABLE 1

| | | Contact |
|---|---|---|
| | Content (wt %) of platinum in | resistance |
| | slurry for first coating layer | (mΩ · cm²) |
| Preparation Example 1 | — | 396.9 |
| Preparation Example 3 | 80 | 26.5 |
| Preparation Example 5 | 83 | 25.0 |
| Preparation Example 6 | 86 | 22.7 |
| Preparation Example 7 | 90 | 22.6 |

As shown in Table 1, compared to the slurry in Preparation Example 1 containing only titanium without containing platinum, the porous transport layers using the slurries in Preparation Examples 3 and 5 to 7 containing platinum have low contact resistances, thereby improving the performance of the hydrogen electrolysis (water electrolysis) stack.

The method for preparing the porous transport layer according to the present disclosure has the effects that the process simplification is possible as the noble metal coating layer may be formed on the surface of the porous transport layer without the additional process operations or equipment, and the roll-to-roll scheme is applicable as the noble metal coating layer is disposed before the sintering process of the PTL. In addition, the porous transport layer prepared by the above preparation method has the excellent PTL protection effect compared to the amount of use of the noble metal, and has the excellent corrosion resistance and electrical conductivity, so that the porous transport layer may be suitably used as the material for the water electrolysis cell or the fuel cell.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for preparing a porous transport layer, the method comprising:
forming a base layer by a first application process using a slurry for the base layer containing particles of a titanium family element;
forming a first coating layer and a second coating layer independently by second and third application processes using a slurry for the first coating layer containing particles of a first noble metal and the particles of the titanium family element, and a slurry for the second coating layer containing particles of a second noble metal, respectively; and
disposing the first coating layer and the second coating layer on both surfaces of the base layer, respectively.

2. The method of claim 1, wherein the titanium family element includes at least one selected from the group consisting of titanium, zirconium, and hafnium.

3. The method of claim 1, wherein each of the first noble metal and the second noble metal includes at least one selected from a group consisting of platinum (Pt), gold (Au), iridium (Ir), ruthenium (Ru), palladium (Pd), rhodium (Rh), silver (Ag), and osmium (Os).

4. The method of claim 1, wherein the first coating layer has an average thickness in a range from 20 to 100 μm,
wherein the base layer has an average thickness in a range from 20 to 1,000 μm,
wherein the second coating layer has an average thickness in a range from 20 to 100 μm.

5. The method of claim 1, wherein each of the first to third application processes is selected from the group consisting of comma coating, slot die coating, gravure coating, lip coating, cap coating, bar coating, doctor blade coating, and tape casting.

6. The method of claim 1, further comprising:
drying one or more of the base layer, the first coating layer, and the second coating layer independently in a temperature range from 60 to 90° C.

7. The method of claim 1, wherein the porous transport layer is prepared in a roll-to-roll scheme.

8. The method of claim 1, wherein each of the slurry for the first coating layer and the slurry for the second coating layer further contains a solvent, a dispersant, and a binder.

9. The method of claim 8, wherein the slurry for the first coating layer contains:
the particles of the first noble metal in an amount of 75 to 95% by weight, and
the particles of the titanium family element in an amount of 1 to 15% by weight, and
the solvent, the dispersant, and the binder in a total amount of 2 to 15% by weight.

10. The method of claim 1, wherein the slurry for the second coating layer further contains the particles of the titanium family element.

11. The method of claim 1, wherein the slurry for the second coating layer contains the particles of the second noble metal in an amount of 80 to 99% by weight, and further contains a solvent, a dispersant, and a binder in a total amount of 1 to 15% by weight.

12. The method of claim 1, wherein the slurry for the base layer further contains a solvent, a dispersant, and a binder.

13. The method of claim 12, wherein the slurry for the base layer contains the particles of the titanium family element in an amount of 75 to 95% by weight, and the solvent, the dispersant, and the binder in a total amount of 2 to 15% by weight.

14. The method of claim 1, further comprising:
removing a solvent and a binder by degreasing a green sheet with the first coating layer and the second coating layer respectively disposed on both of the surfaces of the base layer; and
sintering the degreased green sheet to prepare the porous transport layer.

15. A porous transport layer comprising:
a base layer containing particles of a titanium family element;
a first coating layer disposed on one surface of the base layer, the first coating layer containing particles of a first noble metal and the particles of the titanium family element; and
a second coating layer containing particles of a second noble metal and disposed on the other surface of the base layer.

16. The porous transport layer of claim 15, wherein the titanium family element includes at least one selected from the group consisting of titanium, zirconium, and hafnium.

17. The porous transport layer of claim 15, wherein each of the first noble metal and the second noble metal includes at least one selected from a group consisting of platinum (Pt), gold (Au), iridium (Ir), ruthenium (Ru), palladium (Pd), rhodium (Rh), silver (Ag), and osmium (Os).

18. The porous transport layer of claim 15, wherein the first coating layer has an average thickness in a range from 20 to 100 μm,
wherein the base layer has an average thickness in a range from 20 to 1,000 μm,
wherein the second coating layer has an average thickness in a range from 20 to 100 μm.

19. A water electrolysis cell or a fuel cell comprising the porous transport layer of claim 15.

20. The water electrolysis cell or the fuel cell of claim 19, further comprising a membrane-electrode assembly (MEA) stacked at a side of the second coating layer of the porous transport layer, and an anode separator stacked at a side of a first coating layer.
